(19) United States
(12) Patent Application Publication
(10) Pub. No.: US 2026/0326199 A1
(43) Pub. Date: Oct. 22, 2026

(54) CONDUCTIVE PASTE AND METHOD FOR MANUFACTURING ELECTRONIC COMPONENT

(71) Applicant: SHOEI CHEMICAL INC., Tokyo (JP)

(72) Inventors: Soichiro ESAKI, Tosu-shi (JP); Yuji AKIMOTO, Tosu-shi (JP)

(21) Appl. No.: 19/119,351

(22) PCT Filed: Oct. 13, 2023
(86) PCT No.: PCT/JP2023/037247

§ 371 Date: Apr. 8, 2025

(30) Foreign Application Priority Data
Oct. 19, 2022 (JP) 2022-167904

(51) Int. Cl. B22F 1/145; B22F 1/102; B22F 1/12; H01G 4/248; H01G 4/30; H01G 13/00

(52) U.S. Cl. CPC B22F 1/147; B22F 1/102; B22F 1/12; H01G 13/006; B22F 2301/10; B22F 2304/058; B22F 2304/10; H01G 4/248; H01G 4/30

(57) ABSTRACT

Examples are disclosed that relate to a conductive paste containing: a conductive powder mainly composed of copper; a glass frit; a binder resin; and an organic solvent, wherein, in the conductive powder mainly composed of copper, a volume-based cumulative 50% particle size D50_{C} in laser diffraction particle size distribution measurement is 0.3 μm or more and 4.5 μm or less, a ratio of an average major axis X to an average minor axis Y is 1.0 or more and 3.0 or less, and a ratio of the average major axis X to an average thickness Z is 1.1 or more and 9.0 or less, and the glass frit has a volume-based cumulative 50% particle size D50_{G} of 0.3 μm or more and 2.0 μm or less in laser diffraction particle size distribution measurement.

### TECHNICAL FIELD

The present invention relates to a conductive paste using a conductive powder mainly composed of copper. Particularly, the present invention relates to a conductive paste for forming a terminal electrode of a multilayer electronic component such as a multilayer ceramic capacitor, a multilayer inductor, and a multilayer piezoelectric actuator. In addition, the present invention relates to a method for manufacturing a multilayer electronic component. Particularly, the present invention relates to a method for manufacturing an electronic component by forming a terminal electrode on a laminated body for a multilayer electronic component.

### BACKGROUND ART

Multilayer ceramic electronic components such as a multilayer ceramic capacitor, a multilayer inductor, and a multilayer piezoelectric actuator are generally manufactured as follows.

First, a conductive paste for an internal electrode is printed in a predetermined pattern on a dielectric ceramic green sheet such as a barium titanate-based ceramic. Then, a plurality of such sheets thus produced are laminated and pressed to obtain an unfired laminate in which ceramic green sheets and internal electrode paste layers are alternately laminated. The obtained laminate is cut into chips with a predetermined shape so as to obtain a laminated body. Here, the laminated body may be fired at a high temperature at this point in time or may not be fired at this point in time, and fired simultaneously with a terminal electrode paste layer that is formed later using a conductive paste for a terminal electrode. In this specification, in either case, the laminate in this state before the terminal electrode paste layer is formed is called a “laminated body.”

Then, a conductive paste for a terminal electrode, of which constituent components are a conductive powder, a binder resin, an organic solvent, a glass frit and the like, is printed by a dip printing method or the like on an exposed end of an internal electrode of the laminated body so as to form a conductive paste layer, and then, as necessary, drying is performed, and additionally firing is performed at a high temperature so as to form a terminal electrode.

Furthermore, then, as necessary, a plating layer made of nickel, tin or the like may be formed on the terminal electrode by electroplating or the like.

Conventionally, precious metals such as palladium, silver-palladium, and platinum are used as internal electrode materials. However, there are demands for resource saving and cost reduction, and particularly for fired types, there are demands for preventing the occurrence of delamination and cracks caused by oxidation expansion during firing of palladium and silver-palladium, and thus in recent years, the use of base metals such as nickel, cobalt, and copper has become mainstream. Therefore, as terminal electrode materials, copper, nickel, cobalt, and alloys thereof, in place of conventional silver or silver-palladium, have been used because the copper, nickel, cobalt, and alloys thereof easily form favorable electrical connection with base metal internal electrodes.

When base metals are used for internal electrodes and terminal electrodes in this manner, the terminal electrodes are generally fired in a non-oxidizing atmosphere with as low an oxygen partial pressure as possible, for example, in an inert gas atmosphere with an oxygen content of several ppm to several tens of ppm, at high temperatures with a peak temperature of 800 °C to prevent these base metals from being oxidized during firing.

However, when firing is performed using a metal powder mainly composed of particularly copper in a low-oxygen atmosphere, it is difficult to appropriately remove binders by burning, decomposing, and scattering organic components such as a binder resin. In the early stage of firing at a relatively low temperature, before the glass fluidizes and the copper powder sinters, if the binder is not removed sufficiently, carbon and organic residues are trapped in the film after sintering starts, causing various problems such as blister defects in the subsequent high temperature stage.

Therefore, conventionally, how to efficiently remove the binder in the early stage of firing, and reduce residual carbon before sintering of the copper powder progresses in a high temperature range has been an important issue for conductive pastes using a metal powder mainly composed of a base metal, particularly copper.

As a method for solving this issue, for example, Patent Literature 1 discloses a conductive paste for a terminal electrode in which an aliphatic amine is used as a surface treatment agent for a copper-based conductive powder, as a result the dispersibility of the conductive powder becomes favorable, binder removal properties are significantly improved, and thereby a dense terminal electrode with excellent adhesion and conductivity can be formed.

In addition, Patent Literature 2 discloses a conductive paste which contains a copper powder, a glass frit, and an organic vehicle, and in which the copper powder is a mixture of 0 to 70 vol % of coarse copper powder having an average particle size of 1.0 μm to 3.0 μm, and 30 to 100 vol % of fine copper powder having an average particle size of 0.1 to 0.8 μm. In addition, Patent Literature 2 discloses an electronic component including a laminated body having a plurality of ceramic layers and an internal electrode, and an external electrode which is formed on the outer surface of the laminated body, and is electrically connected to the internal electrode, and moreover is obtained by baking the conductive paste, wherein the carbon content in the external electrode when the sintered density of the external electrode is 80% is 0.007 wt % or less.

### CITATION LIST

### Patent Literature

[Patent Literature 1] Japanese Patent Application Publication No. 2006-004734
[Patent Literature 2] Japanese Patent Application Publication No. 2011-187225

### DISCLOSURE OF INVENTION

### Technical Problem

Incidentally, in recent years, there has been a demand for lowering the firing temperature when the terminal electrode is formed in order to reduce the environmental impact, reduce the manufacturing cost, and reduce the thermal stress on the laminated body. In addition, there is a demand for reducing the size of the electronic component, and accordingly, there is a demand for thinning the terminal electrode. That is, there is a demand for a conductive paste which allows binder removal to be appropriately performed and the firing temperature to be lowered, and is suitable for thinning.

With regard to the conductive pastes described in Patent Literature 1 and Patent Literature 2, it is assumed that the paste is designed to be fired at a high temperature of 800 °C. Therefore, when firing is performed at 800 °C, sintering progressed sufficiently after the binder is removed, and a dense fired film can be obtained. However, when the inventors attempted to fire the above paste at a low temperature of 720 °C, it was found that sintering could not progress sufficiently after the binder was removed within a firing time of several tens of minutes or several hours.

Therefore, an object of the present invention is to provide a conductive paste which allows a thin, dense and highly continuous terminal electrode to be formed while maintaining high productivity even when firing is performed at a low temperature. In addition, an object of the present invention is to provide a method for manufacturing an electronic component including a thin, dense and highly continuous terminal electrode, while maintaining high productivity, even when firing is performed at a low temperature.

### Solution to Problem

In order to achieve the above objects, the inventors have conducted extensive studies, and as a result, found that, when a fine conductive powder mainly composed of copper, in which the volume-based cumulative 50% particle size D50_{C} in laser diffraction particle size distribution measurement is 0.3 μm or more and 4.5 μm or less, the ratio of the average major axis X to the average minor axis Y is 1.0 or more and 3.0 or less, and the ratio of the average major axis X to the average thickness Z is 1.1 or more and 9.0 or less, is combined with a fine glass frit, in which the volume-based cumulative 50% particle size D50_{G} in laser diffraction particle size distribution measurement is 0.3 μm or more and 2.0 μm or less, a thin, dense and highly continuous terminal electrode can be formed while maintaining high productivity even when firing is performed at a low temperature, and completed the present invention.

Specifically, the present invention (1) provides a conductive paste containing; a conductive powder mainly composed of copper; a glass frit; a binder resin; and an organic solvent, wherein
in the conductive powder mainly composed of copper, a volume-based cumulative 50% particle size D50_{C} in laser diffraction particle size distribution measurement is 0.3 μm or more and 4.5 μm or less, a ratio of an average major axis X to an average minor axis Y is 1.0 or more and 3.0 or less, and a ratio of the average major axis X to an average thickness Z defined below is 1.1 or more and 9.0 or less, and the glass frit has a volume-based cumulative 50% particle size D50_{G} of 0.3 μm or more and 2.0 μm or less in laser diffraction particle size distribution measurement.

### (Average Thickness)

The conductive paste containing the conductive powder mainly composed of copper is cast onto a PET film using an applicator to form a coating film with a film thickness of 250 μm, the coating film is dried in an air atmosphere, 150 °C, and 10 minutes to form a dry film, a cross section of the dry film is exposed by ion milling, the cross section of the dry film is observed under a scanning electron microscope, 500 conductive particles are randomly selected, the minor axis is measured as thickness, an average value of the thicknesses is determined, and this average value is defined as an “average thickness.”

In addition, the present invention (2) provides the conductive paste according to (1), wherein the conductive powder mainly composed of copper contains an aliphatic amine on at least a part of the surface.

In addition, the present invention (3) provides the conductive paste according to (2), wherein an amount of the aliphatic amine is 0.01 parts by mass or more and 1.0 part by mass or less with respect to 100 parts by mass of the conductive powder mainly composed of copper.

In addition, the present invention (4) provides the conductive paste according to any one of (1) to (3), wherein, when a volume-based cumulative 10% particle size of the glass frit is defined as D10_{G}, and a volume-based cumulative 90% particle size thereof is defined as D90_{G} in laser diffraction particle size distribution measurement, (D90_{G}−D10_{G})/D50_{G} is 7.5 or less.

In addition, the present invention (5) provides the conductive paste according to any one of (1) to (4), wherein, when a volume-based cumulative 10% particle size of the conductive powder mainly composed of copper is defined as D10_{C}, and a volume-based cumulative 90% particle size thereof is defined as D90_{C} in laser diffraction particle size distribution measurement, (D90_{C}−D10_{C})/D50_{C} is 7.5 or less.

In addition, the present invention (6) provides the conductive paste according to any one of (1) to (5), which satisfies at least any one of a condition in which a ratio of viscosity at a shear rate of 0.4 s⁻¹ to viscosity at a shear rate of 40 s⁻¹ when measured at 25 °C is 2.0 or more and 20.0 or less and a condition in which, when a strain of 1% is applied to the conductive paste at an angular frequency of 1 Hz, a phase difference 5 between the strain and stress generated by the strain has a value of 450 or more and 80° or less.

In addition, the present invention (7) provides the conductive paste according to any one of (1) to (6), which satisfies all of a condition in which an electrode area proportion of a terminal electrode is 90% or more, a condition in which an average value of the maximum thicknesses of the terminal electrodes is 40 μm or less, and a condition in which an average value of the minimum thicknesses of the terminal electrodes is 1.0 μm or more, which are calculated by evaluation tests below.

### <Electrode Area Proportion Evaluation Test of Terminal Electrode>

An evaluation test sample prepared by a method below for preparing an evaluation test sample is observed under a scanning electron microscope in 10 fields of view for each sample, and a proportion of the electrode area in the observation field of view is calculated as an electrode area proportion of the terminal electrode.

### <Maximum Thickness Evaluation Test of Terminal Electrode>

An evaluation test sample prepared by a method below for preparing an evaluation test sample is observed under a scanning electron microscope, and in the evaluation test sample, when a perpendicular line is drawn from an outer periphery of the terminal electrode to an end-face part of the laminated body, a point where the length of the perpendicular line is the largest is measured as the maximum thickness, the maximum thicknesses of the 20 electronic components, for which the maximum thickness thereof is measured, are averaged to calculate an average value of the maximum thicknesses of the terminal electrodes.

### <Minimum Thickness Evaluation Test of Terminal Electrode>

An evaluation test sample prepared by a method below for preparing an evaluation test sample is observed under a scanning electron microscope, and in the evaluation test sample, when a perpendicular line is drawn from an outer periphery of the terminal electrode to an end-face part of the laminated body, the thickness at a point where the length of the perpendicular line is the smallest, and the thickness at the point where a distance between the corner part of the laminated body and the outer periphery of the terminal electrode is shortest are measured, the thickness of the thinnest part among these is measured as the minimum thickness, and the minimum thicknesses of the 20 electronic components, for which the minimum thickness thereof is measured, are averaged to calculate an average value of the minimum thicknesses of the terminal electrodes.

### <Method for Preparing Evaluation Test Sample>

A laminated body having a rectangular parallelepiped shape with a length of 0.6 mm, a width of 0.3 mm, and a height of 0.3 mm and in which a plurality of dielectric layers containing barium titanate and internal electrode layers containing nickel are laminated is prepared, the conductive paste is applied to an end of the laminated body where an internal electrode is exposed by a dip printing method, with the laminated body being lowered at a rate of 300 μm/s and being lifted at a rate of 100 μm/s, the sample is then left in an air atmosphere and 150 °C for 10 minutes, then heated at a temperature increase rate of 50 °C/min in a nitrogen atmosphere, and left for 15 minutes after the temperature reaches 720 °C to form a terminal electrode, 20 electronic components including the terminal electrode are prepared, the 20 electronic components are each embedded in a resin, and in the electronic components, each of the electronic components is cut through the central area of both end-face parts of each electronic component in a lamination direction (direction perpendicular to the dielectric layers and the internal electrode layers) to expose a cross section of each of the electronic components, and thereby an evaluation test sample is prepared.

In addition, the present invention (8) provides a method for manufacturing an electronic component, the method including a laminated body preparing step of preparing a laminated body for a multilayer electronic component including a plurality of ceramic layers and a plurality of internal electrode layers; and a terminal electrode forming step of applying a conductive paste to an exposed end of an internal electrode of the laminated body, and then firing the applied conductive paste, thereby forming a terminal electrode, wherein the conductive paste is the conductive paste according to any one of (1) to (7).

In addition, the present invention (9) provides the method for manufacturing an electronic component according to (7), wherein a peak temperature during firing is 720 °C or lower.

In addition, the present invention (10) provides the conductive paste according to any one of (1) to (7), wherein, when the conductive paste is a fired conductive paste to be used by firing, and the peak temperature during firing is T₁° C, if the glass frit is put into a cylindrical container with an inner diameter of 5 mm, a pressure of 3 MPa is applied in the axial direction for 10 seconds to prepare a cylindrical powder compact with a diameter of 5 mm and a height of 1 mm, the powder compact is placed on a copper plate with a surface roughness Ra of 100 nm so that the flat surface of the powder compact is in contact with the copper plate, and when the powder compact is heated to T₁° C in a nitrogen atmosphere at a temperature increase rate of 10 °C/min, and the glass constituting the powder compact is melted, the contact angle of the glass with respect to the copper plate is 80° or less.

In addition, the present invention (11) provides the conductive paste according to any one of (1) to (7) and (10), wherein viscosity at a shear rate of 4 s⁻¹ is 10.0 Pa-s or more and 80.0 Pa-s or less when measured at 25 °C.

In addition, the present invention (12) provides the method for manufacturing an electronic component according to (8) or (9), wherein an electrode area proportion of the terminal electrode calculated by a calculation method below is 90% or more.

### <Method for Calculating Electrode Area Proportion of Terminal Electrode>

The 20 electronic components are each embedded in a resin, and in the electronic components, each electronic component is cut through the central area of both end-face parts of each electronic component in a lamination direction (direction perpendicular to the dielectric layers and the internal electrode layers) to expose a cross section of each electronic component, the cross section is observed under a scanning electron microscope in 10 fields of view for each electronic component, and the proportion of the electrode area in the observation field of view is calculated as an electrode area proportion.

In addition, the present invention (13) provides the method for manufacturing an electronic component according to any one of (8), (9) and (12), wherein an average value of the maximum thicknesses of the terminal electrodes calculated by a calculation method below is 40 μm or less.

### <Method for Calculating Average Value of Maximum Thicknesses of Terminal Electrodes>

The 20 electronic components are each embedded in a resin, and in the electronic components, each electronic component is cut through the central area of both end-face parts of each electronic component in a lamination direction (direction perpendicular to the dielectric layers and the internal electrode layers) to expose a cross section of each electronic component, the cross section is observed under a scanning electron microscope, and in the cross section, when a perpendicular line is drawn from the outer periphery of the terminal electrode to an end-face part of the laminated body, the point where the length of the perpendicular line is the largest is measured as the maximum thickness, the maximum thicknesses of the 20 electronic components, for which the maximum thickness thereof is measured, are averaged to calculate an average value of the maximum thicknesses of the terminal electrodes.

In addition, the present invention (14) provides the method for manufacturing an electronic component according to any one of (8), (9), (12) and (13), wherein an average value of the minimum thicknesses of the terminal electrodes calculated by the following calculation method is 1.0 μm or more.

### <Method for Calculating Average Value of Minimum Thicknesses of Terminal Electrodes>

The 20 electronic components are each embedded in a resin, and in the electronic components, each electronic component is cut through the central area of both end-face parts of each electronic component in a lamination direction (direction perpendicular to the dielectric layers and the internal electrode layers) to expose a cross section of each electronic component, the cross section is observed under a scanning electron microscope, and in the cross section, when a perpendicular line is drawn from the outer periphery of the terminal electrode to an end-face part of the laminated body, the thickness at the point where the length of the perpendicular line is the smallest and the thickness at the point where a distance between the corner part of the laminated body and an outer periphery of the terminal electrode is shortest are measured, and among these, the thickness of the thinnest part is measured as the minimum thickness, the minimum thicknesses of the 20 electronic components, for which the minimum thickness thereof is measured, are averaged to calculate an average value of the minimum thicknesses of the terminal electrodes.

### Advantageous Effects of Invention

According to the present invention, a thin, dense and highly continuous terminal electrode can be formed while maintaining high productivity even when firing is performed at a low temperature. In addition, it is possible to manufacture an electronic component including a thin, dense and highly continuous terminal electrode while maintaining high productivity even when firing is performed at a low temperature.

### BRIEF DESCRIPTION OF DRAWINGS

FIG. 1 is a schematic view illustrating a method for measuring a fired film thickness of a terminal electrode formed using a conductive paste.

### DESCRIPTION OF EMBODIMENT(S)

### <Conductive Paste>

A conductive paste of the present invention contains a conductive powder mainly composed of copper, a glass frit, a binder resin, and an organic solvent, in which the volume-based cumulative 50% particle size D50_{C} of the conductive powder in laser diffraction particle size distribution measurement is 0.3 μm or more and 4.5 μm or less, the ratio of the average major axis X to the average minor axis Y is 1.0 or more and 3.0 or less, the ratio of the average major axis X to the average thickness Z is 1.1 or more and 9.0 or less, and the volume-based cumulative 50% particle size D50_{G} of the glass frit in laser diffraction particle size distribution measurement is 0.3 μm or more and 2.0 μm or less. Thereby, a thin, dense and highly continuous terminal electrode can be formed while maintaining high productivity even when firing is performed at a low temperature. Particularly, when the conductive powder mainly composed of copper of the present invention contains an aliphatic amine to be described below on at least a part of the surface, the effects of the present invention are more significantly exhibited.

When the above conductive powder mainly composed of copper is used, since the filling property of the conductive powder in the coating film of the conductive paste is improved, sintering of the conductive powder progresses easily even when firing is performed at a low temperature. In addition, when a glass frit having a D50_{G} within the above range is used, since the fine glass frit is uniformly dispersed even inside the unfired film in which the conductive powder is densely filled, the conductive powder is easily sintered uniformly throughout the film, a binder removal path can be appropriately secured throughout the film, and as a result, a thin, dense and highly continuous terminal electrode can be formed. In addition, when the upper limit of D50_{G} is within the above range, the discontinuous part of the terminal electrode due to voids generated after the glass flows is reduced.

Here, when the conductive powder is subjected to a surface treatment, since the dispersibility of the conductive powder is improved, the filling property of the conductive powder in the coating film is further improved. However, since the binder removal path is narrowed due to the improved filling property, binder removal properties deteriorate and since the surface treatment agent itself also needs to be subjected to binder removal, sintering properties actually deteriorate, and other problems such as blister defects caused by insufficient binder removal may occur. In a preferable aspect of the present invention, when an aliphatic amine to be described below is used as a surface treatment agent, the binder can be appropriately removed even when the conductive powder is densely filled. That is, when the conductive powder in the present invention that has been surface-treated with an aliphatic amine is used, the conductive powder is more densely filled in the coating film before firing, and when the glass frit of the present invention is used and the surface treatment agent for the conductive powder is an aliphatic amine, binder removal properties are improved, and thus sintering progresses easily even when firing is performed at a low temperature, and a dense fired film can be obtained more easily.

Regarding the conductive paste of the present invention, the conductive paste is preferably applied to a laminated body or the like to form a coating film, and as necessary, the coating film is dried to form a dry film, and then fired before use. The peak temperature during firing is not particularly limited, and firing can be performed at 600 °C or higher, which is a lower temperature than the conventional firing temperature, and in order to reduce the environmental impact, reduce the manufacturing cost, and reduce the thermal stress on the laminated body, the peak temperature is preferably 600 °C or higher and 720 °C or lower, and particularly preferably 600 °C or higher and 700 °C or lower.

### <Conductive Powder>

The conductive powder in the present invention is mainly composed of copper, and the proportion of copper in the conductive powder is preferably 80 mass % or more and 100 mass % or less, more preferably 90 mass % or more and 100 mass % or less, still more preferably 95 mass % or more and 100 mass % or less, and particularly preferably 100 mass % (pure copper). When the proportion of copper in the conductive powder is within the above range, since the conductive powder is easily sintered, a dense fired film can be obtained more easily. Here, as long as the conductive powder contains copper as a main component, the conductive powder in the present invention may be a mixed powder of a copper powder and other metal element powders such as a nickel powder or silver powder, or may be an alloy powder of copper and other metal elements such as nickel or silver. Furthermore, the conductive powder may be a composite powder in which a copper powder is covered with glass, a ceramic or the like, or may have an oxide film on the surface. Furthermore, one that has been surface-treated with an organometallic compound, a surfactant or the like may be used or a mixture of two or more types of these conductive powders may be used. Here, in this specification, the “main component” means that the component accounts for more than 50 mass % of the total amount, and particularly, means that, in the conductive powder mainly composed of copper, the amount of the copper component is more than 50 mass % with respect to all conductive powders contained in the conductive paste of the present invention containing the above mixed powder, alloy powder and the like.

In the conductive powder mainly composed of copper in the present invention, the volume-based cumulative 50% particle size D50_{C} in laser diffraction particle size distribution measurement is 0.3 μm or more and 4.5 μm or less, and is preferably 0.3 μm or more and 4.0 μm or less, more preferably 0.5 μm or more and 4.0 μm or less, more preferably 0.5 μm or more and 3.0 μm or less, more preferably 0.7 μm or more and 3.0 μm or less, still more preferably 1.0 μm or more and 3.0 μm or less, and particularly preferably 1.5 μm or more and 2.5 μm or less. When the D50_{C} of the conductive powder mainly composed of copper is within the above range, sintering of the conductive powder progresses easily even when firing is performed at a low temperature, and a dense fired film can be easily formed. In addition, a thin fired film can be easily formed.

In the conductive powder mainly composed of copper in the present invention, the ratio of the average major axis X to the average minor axis Y is 1.0 or more and 3.0 or less, and is preferably 1.0 or more and 2.5 or less. When the ratio of the average major axis X to the average minor axis Y in the conductive powder mainly composed of copper is within the above range, even when firing is performed at a low temperature, sintering progresses easily, a dense fired film can be easily formed. In addition, a thin and highly continuous fired film (terminal electrode) can be easily formed.

Both the above average major axis X and average minor axis Y can be measured according to, for example, observation under a scanning electron microscope. That is, the diameters can be measured by randomly selecting a plurality of (for example, 500) conductive particles according to observation under a scanning electron microscope, measuring the major axis and the minor axis, and determining the average values of the diameters. In addition, measurement can be performed using, for example, a flow type particle image analysis device. That is, the diameters can be measured by measuring the major axis and the minor axis of a plurality of (for example, 500) conductive particles using a flow type particle image analysis device, and determining the average values of the diameters. As the flow type particle image analysis device, for example, FPIA-3000S (commercially available from Sysmex Corporation) can be used.

In the conductive powder mainly composed of copper in the present invention, the ratio of the average major axis X to the average thickness Z defined below is 1.1 or more and 9.0 or less, and is preferably 1.1 or more and 7.5 or less, more preferably 1.2 or more and 7.5 or less, more preferably 1.2 or more and 6.0 or less, more preferably 1.5 or more and 5.0 or less, more preferably 1.6 or more and 4.5 or less, more preferably 1.6 or more and 4.0 or less, still more preferably 1.7 or more and 3.0 or less, and particularly preferably 1.8 or more and 2.5 or less. When the ratio of the average major axis X to the average thickness Z in the conductive powder mainly composed of copper is within the above range, sintering progresses easily even when firing is performed at a low temperature, and a dense fired film can be easily formed. In addition, a thin and highly continuous fired film (terminal electrode) can be easily formed.

### (Average Thickness)

The conductive paste containing the conductive powder mainly composed of copper is cast onto a PET film using an applicator to form a coating film with a film thickness of 250 μm, the coating film is dried in an air atmosphere, 150 °C, and 10 minutes to form a dry film, a cross section of the dry film is exposed by ion milling, the cross section of the dry film is observed under a scanning electron microscope, 500 conductive particles are randomly selected, the minor axis is measured as the thickness, and the average value of the thicknesses is determined. This average value is defined as an “average thickness” in this specification (the present invention).

In addition, the above average thickness Z can be measured by observing, for example, a cross section of a dry film formed using the conductive paste of the present invention under a scanning electron microscope. More specifically, for example, the thickness can be measured by casting the conductive paste of the present invention onto a PET film using an applicator to form a coating film with a film thickness of 250 μm, drying the coating film in an air atmosphere, 150 °C, and 10 minutes to form a dry film, exposing a cross section of the dry film by an ion milling device (for example, IM4000, commercially available from Hitachi High-Tech Corporation), observing the cross section of the dry film under a scanning electron microscope (for example, SU-8020, commercially available from Hitachi High-Tech Corporation), randomly selecting a plurality of (for example, 500) conductive particles according to the observation, measuring the minor axis as the thickness, and determining the average value of the thicknesses. As the conductive paste of the present invention, for example, one obtained by mixing 100 parts by mass of a conductive powder mainly composed of copper, an acrylic resin (7 parts by mass of a resin) dissolved in terpineol, and 10 parts by mass of a glass frit, then kneading the sample using a three-roll mill, then diluting it with terpineol, and adjusting the viscosity at 25 °C and a shear rate of 4 s⁻¹ to 30 Pa·s can be used. Here, for example, even if other powders such as a glass frit are contained in addition to the conductive powder mainly composed of copper, the average thickness of the conductive powder mainly composed of copper can be measured by distinguishing it from the other powders. As a distinguishing method, for example, the conductive powder mainly composed of copper and other powders can be distinguished by observing the element distribution in the cross section of the dry film by energy dispersive X-ray spectroscopy (EDX).

The shape of the conductive powder mainly composed of copper in the present invention is not particularly limited as long as D50_{C} is 0.3 μm or more and 4.5 μm or less, the ratio of the average major axis X to the average minor axis Y is 1.0 or more and 3.0 or less, and the ratio of the average major axis X to the average thickness Z is 1.1 or more and 9.0 or less, and may be, for example, a flat shape, a cylindrical shape, an elliptical cylindrical shape, a truncated conical shape, an elliptical truncated conical shape, a rectangular parallelepiped shape or the like. Here, the conductive powder of the present invention does not exclude powders with other shapes such as a true spherical shape, and the conductive powder as a whole may have the above numerical ranges for “D50c,” “the ratio of the average major axis X to the average minor axis Y” and “the ratio of the average major axis X to the average thickness Z.” In this case, the content of the conductive powder that satisfies the above numerical ranges with respect to all conductive powders is not particularly limited, and is preferably more than 50 mass %, more preferably 55 mass % or more, more preferably 60 mass % or more, more preferably 70 mass % or more, more preferably 80 mass % or more, still more preferably 90 mass % or more, and particularly preferably 95 mass % or more.

In the conductive powder mainly composed of copper in the present invention, when the volume-based cumulative 10% particle size of the conductive powder mainly composed of copper is defined as D10_{C}, and the volume-based cumulative 90% particle size thereof is defined as D90_{C} in laser diffraction particle size distribution measurement, (D90_{C}−D10_{C})/D50_{C} is preferably 7.5 or less, more preferably 6.5 or less, more preferably 5.0 or less, more preferably 4.0 or less, still more preferably 3.0 or less, and particularly preferably 2.0 or less. The lower limit value of (D90_{C}−D10_{C})/D50_{C} is not particularly limited, and may be, for example, 0.2 or more. When the (D90_{C}−D10_{C})/D50_{C} of the conductive powder mainly composed of copper is within the above range, that is, the particle size distribution of the conductive powder is narrow, sintering of the conductive powder can progress uniformly throughout the film. That is, since localized progress of sintering within the film can be curbed, a binder removal path can be appropriately secured throughout the film, and as a result, a thin, dense and highly continuous terminal electrode can be formed. In addition, an increase in the film thickness of the terminal electrode caused by the use of extremely large conductive powder can be curbed.

The specific surface area of the conductive powder is preferably 0.2 m²/g or more and 3.0 m²/g or less, and particularly preferably 0.3 m²/g or more and 2.0 m²/g or less. When the specific surface area of the conductive powder mainly composed of copper is within the above range, sintering progresses easily even when firing is performed at a low temperature, and a dense fired film can be easily formed. In addition, a thin fired film can be easily formed.

A method for manufacturing a conductive powder in the present invention is not particularly limited, and for example, a spherical conductive powder can be manufactured by a spray pyrolysis method, a physical vapor deposition method, a chemical vapor deposition method, a liquid phase reduction method, an atomization method or the like, the conductive powder can then be subjected to a surface treatment with a surface treatment agent such as an aliphatic amine to be described below as necessary, and a crushing treatment can then be performed using a bead mill, a ball mill, a stamp mill or the like. In addition, the particle size distribution can be adjusted by performing classification before the crushing treatment or after the crushing treatment as necessary.

### <Glass Frit>

The volume-based cumulative 50% particle size D50_{G} of the glass frit of the present invention in laser diffraction particle size distribution measurement is 0.3 μm or more and 2.0 μm or less and is preferably 0.5 μm or more and 1.5 μm or less. When the D50_{G} of the glass frit is within the above range, a dense fired film can be easily formed, and a highly continuous fired film (terminal electrode) can be easily formed.

In the glass frit of the present invention, when the volume-based cumulative 10% particle size is defined as D10_{G}, and the volume-based cumulative 90% particle size is defined as D90_{G} in laser diffraction particle size distribution measurement, (D90_{G}−D10_{G})/D50_{G} is preferably 7.5 or less, more preferably 6.5 or less, more preferably 5.0 or less, still more preferably 3.5 or less, and particularly preferably 2.5 or less. The lower limit value of (D90_{G}−D10_{G})/D50_{G} is not particularly limited, and may be, for example, 0.2 or more. When the (D90_{G}−D10_{G})/D50_{G} of the glass frit is within the above range, that is, the particle size distribution of the glass frit is narrow, since the glass frit with a uniform size is uniformly distributed even inside the unfired film in which the conductive powder is densely filled, the conductive powder is easily sintered uniformly throughout the film. In addition, accordingly, since localized progress of sintering within the film can be curbed, a binder removal path can be appropriately secured throughout the film, and as a result, a thin, dense and highly continuous terminal electrode can be formed. Since the amount of extremely small glass frits that are present in an aggregate state and easily soften and flow is small, localized progress of sintering and localized binder removal failure caused by the progress of sintering are easily curbed. In addition, when the amount of extremely large glass frits is small, since exposure of the laminated body due to voids that are generated in places where the glass frit flows in the firing procedure can be reduced, the continuity of the terminal electrode can be improved.

When the conductive paste of the present invention is a fired conductive paste to be used by firing, and the peak temperature during firing is T₁° C, if the glass frit is put into a cylindrical container with an inner diameter of 5 mm, a pressure of 3 MPa is applied in the axial direction for 10 seconds to prepare a cylindrical powder compact with a diameter of 5 mm and a height of 1 mm, the powder compact is placed on a copper plate with a surface roughness Ra of 100 nm so that the flat surface of the powder compact is in contact with the copper plate, and when the powder compact is heated to T₁° C in a nitrogen atmosphere at a temperature increase rate of 10 °C/min, and the glass constituting the powder compact is melted, the contact angle of the glass with respect to the copper plate is preferably 800 or less, more preferably 75° or less, more preferably 70° or less, more preferably 650 or less, still more preferably 600 or less, and particularly preferably 55° or less. The lower limit value of the contact angle of the glass with respect to the copper plate is not particularly limited, and may be, for example, 10° or more. When the contact angle of the glass with respect to the copper plate is within the above range, the wettability of the glass with respect to the conductive powder mainly composed of copper is improved, the flow of the glass is curbed up to a desired temperature in order to appropriately perform binder removal, and once the desired temperature is reached, the glass can quickly wet and spread in the vicinity of the conductive powder, and thus a thin, dense and highly continuous terminal electrode can be easily formed.

The composition of the glass frit in the present invention is not particularly limited, and for example, BaO—ZnO-based, BaO—ZnO—B₂O₃-based, RO—ZnO—B₂O₃—MnO₂-based, RO—ZnO-based, RO—ZnO—MnO₂-based, RO—ZnO—SiO₂-based, ZnO—B₂O₃-based, SiO₂—B₂O₃—R′₂O-based, and SiO₂—RO—R′₂O-based (provided that R is an alkaline earth metal element, and R′ is an alkaline metal element) glasses can be used.

In the present invention, the glass transition temperature of the glass frit is preferably 400 °C or higher and 550 °C or lower. When the glass transition temperature of the glass frit is within the above range, since the glass easily wets and spreads throughout the film even when firing is performed at a low temperature, a dense fired film can be easily formed.

In the present invention, the softening point of the glass frit is preferably 500 °C or higher and 650 °C or lower. When the softening point of the glass frit is within the above range, since the glass easily wets and spreads throughout the film even when firing is performed at a low temperature, a dense fired film can be easily formed.

The specific surface area of the glass frit is preferably 2.0 m²/g or more and 7.0 m²/g or less, and particularly preferably 3.0 m²/g or more and 6.0 m²/g or less. When the specific surface area of the glass frit is within the above range, since the glass frit is easily dispersed uniformly in the film, a dense fired film can be easily formed.

The amount of the glass frit with respect to 100 parts by mass of the conductive powder is preferably 1 part by mass or more and 20 parts by mass or less, more preferably 4 parts by mass or more and 18 parts by mass or less, still more preferably 6 parts by mass or more and 16 parts by mass or less, and particularly preferably 8 parts by mass or more and 14 parts by mass or less. When the amount of the glass frit is within the above range, a dense fired film can be easily formed.

### <Surface Treatment Agent>

The conductive powder mainly composed of copper in the present invention preferably contains an aliphatic amine on at least a part of the surface. When the conductive powder mainly composed of copper contains an aliphatic amine on at least a part of the surface, since the conductive powder mainly composed of copper can be prevented from being oxidized and the conductive powder can be well dispersed in the paste, the filling property of the conductive powder in the coating film of the conductive paste of the present invention can be improved, and accordingly, a fired film having an excellent density can be formed even when firing is performed at a low temperature. In addition, since the conductive powder can be well dispersed in the paste, a thin and highly continuous terminal electrode can be easily formed.

The amount of the aliphatic amine in the present invention with respect to 100 parts by mass of the conductive powder mainly composed of copper is preferably 0.01 parts by mass or more and 1.0 part by mass or less, more preferably 0.02 parts by mass or more and 1.0 part by mass or less, more preferably 0.03 parts by mass or more and 1.0 part by mass or less, more preferably 0.04 parts by mass or more and 1.0 part by mass or less, more preferably 0.05 parts by mass or more and 1.0 part by mass or less, and particularly preferably 0.1 parts by mass or more and 0.5 parts by mass or less. When the amount of the aliphatic amine is within the above range, since the dispersibility of the conductive powder in the paste is improved and binder removal properties are improved during firing, a thin, dense and highly continuous terminal electrode can be easily formed.

As the aliphatic amine in the present invention, various amines, for example, primary amines such as octylamine, laurylamine, myristylamine, stearylamine, oleylamine, beef tallow amine, and beef tallow propylenediamine, secondary amines such as distearylamine, and tertiary amines such as triethylamine, dimethyl octylamine, dimethyl myristylamine, dimethyl palmitylamine, dimethyl stearylamine, dimethyl behenylamine, dimethyl laurylamine, and trioctylamine can be used. Two or more types of these amines may be used in combination, and a mixture of several types of aliphatic amines that are generally commercially available as “aliphatic amine” may also be used. Particularly, in consideration of ease of a coating treatment on the copper powder and adsorption to metals, alkylamines having about 8 to 20 carbon atoms in the main chain or aliphatic amines having alkylamines as the main component are preferable.

### <Binder Resin>

The binder resin in the present invention is not particularly limited, and an acrylic resin is preferably contained. The proportion of the acrylic resin with respect to the entire binder resin is preferably more than 50 mass %, more preferably 60 mass % or more, more preferably 70 mass % or more, still more preferably 80 mass % or more, and particularly preferably 90 mass % or more. When an acrylic resin is used, since thermal decomposition properties are excellent in a nitrogen atmosphere, the binder resin can be successfully removed without oxidizing copper.

The amount of the binder resin with respect to 100 parts by mass of the conductive powder is not particularly limited, and is preferably 3 parts by mass or more and 11 parts by mass or less, more preferably 4 parts by mass or more and 10 parts by mass or less, still more preferably 5 parts by mass or more and 9 parts by mass or less, and particularly preferably 6 parts by mass or more and 8 parts by mass or less. When the amount of the binder resin is within the above range, a thin, dense and highly continuous terminal electrode can be easily formed.

The weight average molecular weight of the acrylic resin is not particularly limited, and for example, one having a weight average molecular weight of 20,000 or more and 1,000,000 or less can be used. Here, two or more types of acrylic resins with different weight average molecular weights, structures and the like may be used in combination.

### <Organic Solvent>

The organic solvent in the present invention is not particularly limited, and examples thereof include terpineol, dihydroterpineol, dihydroterpineol acetate, secondary butyl alcohol, butyl carbitol, butyl carbitol acetate, and benzyl alcohol.

### <Additive>

The conductive paste of the present invention can contain, as necessary, additives such as a defoaming agent, a plasticizer, a dispersant, and a rheology adjusting agent, in addition to the above components, as long as the effects of the present invention are not impaired. Examples of plasticizers include dimethyl phthalate, diethyl phthalate, dibutyl phthalate, di-2-ethylhexyl phthalate, di-n-octyl phthalate, butyl benzyl phthalate, dioctyl adipate, diisononyl adipate, dibutyl sebacate, diethyl sebacate, dioctyl sebacate, tricresyl phosphate, chlorinated paraffin, and cyclohexane-1,2-dicarboxylic acid diisononyl ester. Examples of rheology adjusting agents include a silica powder.

### <Physical Properties of Conductive Paste>

The viscosity of the conductive paste of the present invention at a shear rate of 4 s⁻¹ when measured at 25 °C is not particularly limited, and is preferably 10.0 Pa-s or more and 80.0 Pa-s or less, and particularly preferably 20.0 Pa-s or more and 60.0 Pa-s or less. When the viscosity of the conductive paste is within the above range, a thin, dense and highly continuous terminal electrode can be easily formed.

The ratio of the viscosity at a shear rate of 0.4 s⁻¹ to the viscosity at a shear rate of 40 s⁻¹ of the conductive paste of the present invention when measured at 25 °C is not particularly limited, and is preferably 2.0 or more and 20.0 or less, and particularly preferably 3.0 or more and 8.0 or less. When the ratio of the viscosity of the conductive paste is within the above range, a thin, dense and highly continuous terminal electrode can be easily formed.

When a strain of 1% is applied to the conductive paste of the present invention at an angular frequency of 1 Hz, the value of the phase difference 6 between the strain and stress generated by the strain is not particularly limited, and is preferably 450 or more and 80° or less, and particularly preferably 45° or more and 78° or less. When the value of the phase difference 6 of the conductive paste is within the above range, a thin, dense and highly continuous terminal electrode can be easily formed.

For the conductive paste of the present invention, for example, using an evaluation test sample prepared by the following method, the electrode area proportion of terminal electrodes to be described below, the average value of the maximum thicknesses of the terminal electrodes, and the average value of the minimum thicknesses of the terminal electrodes can be calculated. The evaluation test samples can be prepared as follows. For example, a laminated body having a rectangular parallelepiped shape with a length of 0.6 mm, a width of 0.3 mm, and a height of 0.3 mm in which a plurality of dielectric layers containing barium titanate and internal electrode layers containing nickel are laminated is prepared, the conductive paste is applied to an end of the laminated body where an internal electrode is exposed by a dip printing method with the laminated body lowered at a rate of 300 μm/s and lifted at a rate of 100 μm/s, the sample is then left in an air atmosphere and 150 °C for 10 minutes, then heated at a temperature increase rate of 50 °C/min in a nitrogen atmosphere, and left for 15 minutes after the temperature reaches 700 °C or 720 °C to form a terminal electrode, 20 electronic components including the terminal electrode are prepared, the 20 electronic components are each embedded in a resin, and in the electronic components, each electronic component is cut through the central area of both end-face parts of each electronic component in a lamination direction (direction perpendicular to the dielectric layers and the internal electrode layers) to expose a cross section of each electronic component.

### <Method for Manufacturing Electronic Component>

The conductive paste of the present invention is suitable as a conductive paste for forming an electrode on an electrode-forming body (hereinafter also referred to as an electrode-forming body for an electronic component) on which an electrode is formed in the manufacturing of the electronic component, and is particularly suitable as a conductive paste for forming a terminal electrode on a laminated body for a multilayer electronic component.

A suitable method for manufacturing an electronic component using the conductive paste of the present invention is a method for manufacturing an electronic component including a preparing step in which an electrode-forming body for an electronic component is prepared and an electrode forming step in which a conductive paste is applied onto the outer surface of the electrode-forming body for an electronic component and the applied conductive paste is then fired to form an electrode, and in the method for manufacturing an electronic component, an electrode is formed on the electrode-forming body for an electronic component using the conductive paste of the present invention. When the conductive paste of the present invention is used in the above method for manufacturing an electronic component, even when firing is performed at a low temperature in the electrode forming step, a thin, dense and highly continuous electrode can be formed while maintaining high productivity. That is, according to the above method for manufacturing an electronic component, in the electrode forming step, even when firing is performed at a low temperature, an electronic component including a thin, dense and highly continuous electrode can be manufactured while maintaining high productivity.

The preparing step is a step in which an electrode-forming body for an electronic component is prepared. The electrode-forming body for an electronic component refers to a component on which an electrode is formed in an electronic component manufacturing step. Examples of electrode-forming bodies for an electronic component include a laminated body for a multilayer electronic component having a plurality of ceramic layers and a plurality of internal electrode layers, and a cathode-forming body for a solid electrolytic capacitor including an anode and a dielectric layer formed on the surface of the anode.

The electrode forming step is a step in which a conductive paste is applied onto the outer surface of the electrode-forming body for an electronic component and the applied conductive paste is fired to form an electrode. Examples of methods of applying a conductive paste include a dip printing method, a screen printing method, and a roll coating method. Among these, a dip printing method is preferable.

In the electrode forming step, the position of the electrode formed, the electrode forming method, the thickness of the electrode, the number of electrodes, the type of metals constituting the electrode, the shape of the conductive powder used to form the electrode, and the like are appropriately selected depending on the electronic component to be manufactured.

In the electrode forming step, after an electrode is formed on an electrode-forming body for an electronic component, an appropriate step can be provided depending on the type of the electronic component. For example, in the case of a multilayer electronic component, in the electrode forming step, an electrode is formed at a predetermined position of a laminated body for an electronic component, and a plating layer is then formed on the surface of the electrode.

A particularly suitable method for manufacturing an electronic component using the conductive paste of the present invention is a method for manufacturing an electronic component including a laminated body preparing step in which a laminated body for a multilayer electronic component having a plurality of ceramic layers and a plurality of internal electrode layers is prepared and a terminal electrode forming step in which a conductive paste is applied to an exposed end of an internal electrode of the laminated body, and the applied conductive paste is then fired to form a terminal electrode, and in the method for manufacturing an electronic component, a terminal electrode is formed on the laminated body using the conductive paste of the present invention. When the conductive paste of the present invention is used in the above method for manufacturing an electronic component, even when firing is performed at a low temperature in the terminal electrode forming step, a thin, dense and highly continuous terminal electrode can be formed while maintaining high productivity. That is, according to the above method for manufacturing an electronic component, in the terminal electrode forming step, it is possible to manufacture an electronic component including a thin, dense and highly continuous terminal electrode while maintaining high productivity even when firing is performed at a low temperature.

The laminated body for a multilayer electronic component has a plurality of ceramic layers and a plurality of internal electrode layers. In the laminated body for a multilayer electronic component, ceramic layers and internal electrode layers are alternately laminated. Examples of laminated bodies for a multilayer electronic component include a laminated body for a laminated ceramic capacitor, a laminated body for a laminated ceramic inductor, and a laminated body for a piezoelectric actuator.

Examples of materials forming ceramic layers constituting the laminated body for a multilayer electronic component include barium titanate, strontium titanate, calcium titanate, barium zirconate, strontium zirconate, calcium zirconate, and strontium calcium zirconate.

Examples of materials forming the internal electrode layers constituting the laminated body for a multilayer electronic component include nickel, palladium, silver, copper and gold or an alloy containing one or more of these components (for example, an alloy of silver and palladium).

In the terminal electrode forming step, the conductive paste of the present invention is applied to an exposed end of an internal electrode of a laminated body for a multilayer electronic component, and the applied conductive paste is fired to form a terminal electrode. The method for applying a conductive paste is not particularly limited, and examples thereof include a dip printing method, a screen printing method, and a roll coating method. Among these, a dip printing method is preferable. Here, the conductive paste may be applied to the laminated body, then dried and then fired.

Here, in this specification, both ends of the laminated body where internal electrodes are exposed are referred to as “ends,” particularly the surfaces of the ends where internal electrodes are exposed are referred to as “end-face parts,” and the outer edge parts of the end-face parts of the ends are referred to as “corner parts.” Generally, in the terminal electrode forming step, when the conductive paste is applied to the ends, the conductive paste is applied to cover the end-face parts and the corner parts.

The size of the laminated body in which the conductive paste of the present invention is used is not particularly limited, and the conductive paste can be used for, for example, a laminated body for a 2012 size laminated ceramic capacitor, a laminated body for a 1608 size laminated ceramic capacitor, a laminated body for a 1005 size laminated ceramic capacitor, a laminated body for a 0603 size laminated ceramic capacitor, a laminated body for a 0402 size laminated ceramic capacitor, and a laminated body for a 0201 size laminated ceramic capacitor. Thinning of the terminal electrode is particularly required in small laminated ceramic capacitors, and the conductive paste of the present invention can be suitably used in a laminated body for a 1005 size laminated ceramic capacitor, a laminated body for a 0603 size laminated ceramic capacitor, a laminated body for a 0402 size laminated ceramic capacitor, and a laminated body for a 0201 size laminated ceramic capacitor.

The electrode area proportion of the terminal electrode of the multilayer electronic component obtained by the present invention is not particularly limited, and is preferably 90% or more and particularly preferably 99% or more. Thereby, it is easy to prevent the plating solution from entering the laminated body when plating the terminal electrode. Here, the above electrode area proportion can be calculated, for example, by the following method. That is, a plurality of (for example, 20) electronic components are each embedded in a resin, and in the electronic components, each electronic component is cut through the central area of both end-face parts of each electronic component in a lamination direction (direction perpendicular to the dielectric layers and the internal electrode layers) to expose a cross section of each electronic component, the cross section is observed under a scanning electron microscope (for example, 10 fields of view for each electronic component), and the proportion of the electrode area in the observation field of view can be calculated as an electrode area proportion.

The maximum thickness of the terminal electrode measured by the following method is preferably 40 μm or less, more preferably 30 μm or less, more preferably 20 μm or less, still more preferably 15 μm or less, and particularly preferably 10 μm or less. In addition, the average value of the maximum thickness of the terminal electrodes calculated by the following method is preferably 40 μm or less, more preferably 30 μm or less, more preferably 20 μm or less, still more preferably 15 μm or less, and particularly preferably 10 μm or less. Thereby, it is possible to reduce the size of the multilayer electronic component. In addition, in a multilayer electronic component with a predetermined size, as the terminal electrode is thinner, the size of the laminated body can be increased, that is, the electrode area and the number of laminations can be increased, and thus the performance of the multilayer electronic component is improved. Here, the method for measuring the maximum thickness is not particularly limited, and for example, an electronic component is embedded in a resin, the electronic component is cut through the central area of both end-face parts of the electronic component in a lamination direction (direction perpendicular to the dielectric layers and the internal electrode layers) to expose a cross section of the electronic component, the cross section is observed under a scanning electron microscope, and in the cross section, when a perpendicular line is drawn from the outer periphery of the terminal electrode to an end-face part of the laminated body, the point where the length of the perpendicular line is the largest can be measured as the maximum thickness. In addition, the method for calculating the average value of the maximum thicknesses is not particularly limited, and for example, using a plurality of (for example, 20) electronic components, the maximum thicknesses of the terminal electrodes are measured by the above method, and the maximum thicknesses can be averaged to calculate an average value of the maximum thicknesses of the terminal electrodes.

The minimum thickness of the terminal electrode measured by the following method is preferably 1.0 μm or more, more preferably 2.5 μm or more, and particularly preferably 5.0 μm or more. In addition, the average value of the minimum thicknesses of the terminal electrodes calculated by the following method is preferably 1.0 μm or more, more preferably 2.5 μm or more, and particularly preferably 5.0 μm or more. Thereby, it is easy to prevent the plating solution from entering the laminated body when plating the terminal electrode. Here, the method for measuring the minimum thickness is not particularly limited, and for example, an electronic component is embedded in a resin, the electronic component is cut through the central area of both end-face parts of the electronic component in a lamination direction (direction perpendicular to the dielectric layers and the internal electrode layers) to expose a cross section of the electronic component, the cross section is observed under a scanning electron microscope, and in the cross section, when a perpendicular line is drawn from the outer periphery of the terminal electrode to an end-face part of the laminated body, the thickness at the point where the length of the perpendicular line is the smallest and the thickness at the point where the distance between the corner part of the laminated body and the outer periphery of the terminal electrode is shortest are measured, and among these, the thickness of the thinnest part can be measured as the minimum thickness. In addition, the method for calculating the average value of the minimum thicknesses is not particularly limited, and for example, using a plurality of (for example, 20) electronic components, the minimum thicknesses of the terminal electrodes are measured by the above method, and the minimum thicknesses can be averaged to calculate an average value of the minimum thicknesses of the terminal electrodes.

Hereinafter, the present invention will be described with reference to specific experiment examples, but the present invention is not limited thereto.

### EXAMPLES

### <Preparation of Conductive Powder>

First, a plurality of types of spherical copper powder and spherical silver powder with different particle sizes were prepared, the particle size distribution and particle size were adjusted by classification. Next, zirconia beads with a diameter of 0.1 mm, spherical copper powder, secondary butyl alcohol, and a predetermined surface treatment agent (aliphatic amine) were mixed, crushed using a bead mill by appropriately adjusting a flow rate and the number of passes, and additionally, as necessary, a classification treatment was then performed to adjust the particle size distribution and particle size, and copper powders 1 to 22 and a silver powder 1 shown in Table 1 were obtained. Here, the copper powder 1, the copper powder 3 and the silver powder 1 were not subjected to the above crushing treatment. The copper powder 3 and the silver powder 1 were obtained by performing a surface treatment using a predetermined surface treatment agent (aliphatic amine). Regarding the obtained copper powders 1 to 22 and silver powder 1, the major axes and minor axes of 500 copper particles (silver particles in the case of the silver powder 1, and copper particles and silver particles in the case of the mixed powder C) were measured according to observation under a scanning electron microscope, and an average major axis and an average minor axis were calculated. In addition, conductive pastes prepared in Experiment Examples 1 to 16, and 20 to 25 to be described below were cast onto a PET film using an applicator to form a coating film with a film thickness of 250 μm, the coating film was dried in an air atmosphere, 150 °C, and 10 minutes to form a dry film, a cross section of the dry film was exposed using an ion milling device (model number: IM4000, commercially available from Hitachi High-Tech Corporation), the cross section of the dry film was observed under a scanning electron microscope (model number: SU-8020, commercially available from Hitachi High-Tech Corporation), 500 copper particles were randomly selected according to the observation, the minor axis was measured, and an average thickness was calculated using the minor axis as the thickness. From the average major axis, average minor axis, and average thickness calculated above, the ratio of the average major axis to the average thickness and the ratio of the average major axis to the average minor axis were calculated. In addition, the volume-based cumulative 10% particle size D10, the volume-based cumulative 50% particle size D50, and the volume-based cumulative 90% particle size D90 were measured using a laser diffraction particle size distribution measurement device (LA-960, commercially available from HORIBA, Ltd.), and (D90−D10)/D50 was calculated using the measured values. Here, a powder obtained by mixing the copper powder 3 and the copper powder 5 at a mass ratio of 20:80 (used in Experiment Example 18 to be described below) was set as a mixed powder A, a powder obtained by mixing the copper powder 3 and the copper powder 5 at a mass ratio of 45:55 (used in Experiment Example 19 to be described below) was set as a mixed powder B, a powder obtained by mixing the copper powder 5 and the silver powder 1 at a mass ratio of 90:10 (used in Experiment Example 17 to be described below) was set as a mixed powder C, and “the ratio of the average major axis to the average thickness,” “the ratio of the average major axis to the average minor axis,” “D50” and “(D90−D10)/D50” of the mixed powder (as a whole conductive powder) were measured and calculated by the above methods. The average thicknesses of the mixed powders A to C were measured and calculated in the same methods as described above, except that the conductive pastes prepared in Experiment Examples 17 to 19 were used. The average thickness of the silver powder 1 was measured and calculated in the same method as above except that the silver powder 1 was used in place of the copper powder 1, a conductive paste was prepared in the same method as in Experiment Example 1, and the conductive paste was used. These results are shown in Table 1.

TABLE 1

| | Average major | Average major | | (D90_{C} − |
|---|---|---|---|---|
| Conductive powder | axis X/average | axis X/average | D50_{C} | D10_{C})/ |
| No. | thickness Z | minor axis Y | [μm] | D50_{C} |
| Copper powder 1 | 1.0 | 1.0 | 2.0 | 1.4 |
| Copper powder 2 | 1.9 | 1.3 | 2.3 | 1.5 |
| Copper powder 3 | 1.0 | 1.0 | 2.0 | 1.4 |
| Copper powder 4 | 1.2 | 1.1 | 2.1 | 1.6 |
| Copper powder 5 | 2.1 | 1.3 | 2.4 | 1.5 |
| Copper powder 6 | 4.9 | 1.5 | 2.7 | 1.4 |
| Copper powder 7 | 7.5 | 1.9 | 2.8 | 1.5 |
| Copper powder 8 | 10.8 | 2.3 | 2.9 | 1.6 |
| Copper powder 9 | 2.0 | 1.3 | 0.2 | 1.7 |
| Copper powder 10 | 2.1 | 1.4 | 0.3 | 1.7 |
| Copper powder 11 | 2.1 | 1.6 | 0.7 | 1.6 |
| Copper powder 12 | 1.9 | 1.4 | 2.9 | 1.4 |
| Copper powder 13 | 2.0 | 1.6 | 4.0 | 1.4 |
| Copper powder 14 | 2.0 | 1.8 | 5.3 | 1.4 |
| Copper powder 15 | 2.0 | 1.3 | 2.2 | 4.8 |
| Copper powder 16 | 2.1 | 1.4 | 2.3 | 8.1 |
| Copper powder 17 | 2.0 | 1.3 | 2.3 | 1.6 |
| Copper powder 18 | 2.1 | 1.3 | 2.3 | 1.5 |
| Copper powder 19 | 1.9 | 1.4 | 2.3 | 1.6 |
| Copper powder 20 | 1.9 | 1.3 | 2.3 | 1.6 |
| Copper powder 21 | 2.0 | 1.4 | 2.3 | 1.7 |
| Copper powder 22 | 2.1 | 1.4 | 2.4 | 1.7 |
| Silver powder 1 | 1.0 | 1.0 | 1.0 | 0.5 |
| Mixed powder A | 1.8 | 1.2 | 2.3 | 1.5 |
| Mixed powder B | 1.6 | 1.2 | 2.2 | 1.5 |
| Mixed powder C | 1.8 | 1.3 | 4.6 | 1.2 |

### <Preparation of Glass Frit>

BaO—ZnO-based glass (BaO: 30 mol %, ZnO: 27 mol %, B₂O₃: 25 mol %, SiO₂: 7 mol %, CaO: 7 mol %, Al₂O₃: 4 mol %) was prepared, and the particle size and the particle size distribution were adjusted by crushing and classification to prepare glass frits 1 to 8 shown in Table 2. The volume-based cumulative 10% particle size D10_{G}, the volume-based cumulative 50% particle size D50_{G}, and the volume-based cumulative 90% particle size D90_{G} of the prepared glass frits were measured using a laser diffraction particle size distribution measurement device (LA-960, commercially available from HORIBA, Ltd.). (D90_{G}−D10_{G})/D50_{G} was calculated using the measured values. In addition, the glass transition temperature and the softening point of the above glass frits were measured. In addition, the above glass frit was put into a cylindrical container with an inner diameter of 5 mm, a pressure of 3 MPa was applied in the axial direction for 10 seconds to prepare a cylindrical powder compact with a diameter of 5 mm and a height of 1 mm, the powder compact was placed on a copper plate with a surface roughness Ra of 100 nm so that the flat surface of the powder compact was in contact with the copper plate, and when the powder compact was heated to 700 °C in a nitrogen atmosphere at a temperature increase rate of 10 °C/min, and the glass constituting the powder compact was melted, the contact angle of the glass with respect to the copper plate was measured. Here, regarding the glass frit 4, the contact angle was measured when the temperature was raised to 680 °C and 720 °C, and the contact angle was 50°, similar to the contact angle at 700 °C.

TABLE 2

| | | | | Glass | |
|---|---|---|---|---|---|
| | | (D90_{G} − | | transition | Softening |
| | D50_{G} | D10_{G})/ | Contact | temperature | point |
| Glass frit No. | [μm] | D50_{G} | angle [°] | [°C] | [°C] |
| Glass frit 1 | 0.2 | 2.1 | 53 | 497 | 596 |
| Glass frit 2 | 0.3 | 2.0 | 50 | 495 | 594 |
| Glass frit 3 | 0.5 | 2.2 | 51 | 501 | 599 |
| Glass frit 4 | 1.1 | 2.1 | 50 | 504 | 605 |
| Glass frit 5 | 1.9 | 2.1 | 53 | 501 | 603 |
| Glass frit 6 | 4.6 | 2.0 | 53 | 503 | 605 |
| Glass frit 7 | 0.5 | 4.7 | 52 | 499 | 600 |
| Glass frit 8 | 0.6 | 7.8 | 54 | 500 | 603 |

### <Preparation of Conductive Paste>

Conductive powders, binder resins, and glass frits were mixed in formulation proportions shown in Tables 3 to 6 to prepare conductive pastes. Here, the amount of the surface treatment agent shown in the tables indicates the amount of the surface treatment agent attached to the surface of the powder according to a surface treatment performed when the above conductive powder was prepared.

### Copper Powders 1 to 22, and Silver Powder 1

The ratio of the average major axis X to the average thickness Z, the ratio of the average major axis X to the average minor axis Y, D50, and (D90−D10)/D50 are as shown in Table 1.

### Acrylic Resin 1

Model number: Dianal MB-2677 (commercially available from Mitsubishi Chemical Corporation), weight average molecular weight: 700,000

### Acrylic Resin 2

Model number: Dianal BR-105 (commercially available from Mitsubishi Chemical Corporation), weight average molecular weight: 50,000

### Glass Frits 1 to 8

D50_{G}, (D90_{G}−D10_{G})/D50_{G}, the contact angle with respect to copper plate, the softening point, and the glass transition temperature are as shown in Table 2.

### Experiment Examples 1 to 35, 41, and 42

Conductive powders shown in Table 1, glass frits shown in Table 2, and an acrylic resin 1 dissolved in terpineol were mixed in formulation proportions shown in Tables 3 to 6, the mixtures were then kneaded using a three-roll mill (commercially available from INOUE MFG., INC.), and then diluted with terpineol, the viscosity at 25 °C and a shear rate of 4 s⁻¹ was adjusted to the values shown in Tables 3 to 6 to prepare conductive pastes. The following evaluation was performed using the prepared conductive pastes. The results are shown in Tables 3 to 6. Here, the experiment examples marked with “*” are experiment examples outside the scope of the present invention.

### Experiment Examples 36 to 40

Conductive powders shown in Table 1, glass frits shown in Table 2, and an acrylic resin 1 or an acrylic resin 2 dissolved in terpineol were mixed in formulation proportions shown in Tables 3 to 6, the mixtures were then kneaded using a three-roll mill (commercially available from INOUE MFG., INC.), and then diluted with terpineol and as necessary, dipropylene glycol-n-propyl ether, and the viscosity and viscosity ratio at 25 °C and a shear rate of 4 s⁻¹ were adjusted to the values shown in Table 6 to prepare conductive pastes. The following evaluation was performed using the prepared conductive pastes. The results are shown in Table 6.

### Experiment Example 43

In this experiment example, the conductive paste prepared in Experiment Example 5 was used. When evaluating the terminal electrode, the terminal electrode was evaluated in the same method as in Experiment Example 5 except that, as the laminated body, a laminated body having a substantially rectangular parallelepiped shape with a length of 0.4 mm, a width of 0.2 mm, and a height of 0.2 mm in which a plurality of dielectric layers containing barium titanate and internal electrode layers containing nickel were laminated was used.

TABLE 3

| | | | Exper- | Exper- | Exper- | Exper- | Exper- | Exper- | Exper- |
|---|---|---|---|---|---|---|---|---|---|
| | | | iment | iment | iment | iment | iment | iment | iment |
| | | | Exam- | Exam- | Exam- | Exam- | Exam- | Exam- | Exam- |
| | | | ple | ple | ple | ple | ple | ple | ple |
| | | | 1 * | 2 | 3 * | 4 | 5 | 6 | 7 |
| Paste | Conductive | Copper powder 1 | 100 | — | — | — | — | — | — |
| composition | powder | Copper powder 2 | — | 100 | — | — | — | — | — |
| [parts | | Copper powder 3 | — | — | 100 | — | — | — | — |
| by mass] | | Copper powder 4 | — | — | — | 100 | — | — | — |
| | | Copper powder 5 | — | — | — | — | 100 | — | — |
| | | Copper powder 6 | — | — | — | — | — | 100 | — |
| | | Copper powder 7 | — | — | — | — | — | — | 100 |
| | | Copper powder 8 | — | — | — | — | — | — | — |
| | | Copper powder 9 | — | — | — | — | — | — | — |
| | | Copper powder 10 | — | — | — | — | — | — | — |
| | | Copper powder 11 | — | — | — | — | — | — | — |
| | | Copper powder 12 | — | — | — | — | — | — | — |
| | | Copper powder 13 | — | — | — | — | — | — | — |
| | | Copper powder 14 | — | — | — | — | — | — | — |
| | Surface | Dimethyl stearylamine | — | — | 0.2 | 0.2 | 0.2 | 0.2 | 0.2 |
| | treatment agent | | | | | | | | |
| | Binder resin | Acrylic resin 1 | 7 | 7 | 7 | 7 | 7 | 7 | 7 |
| | Glass frit | Glass frit 4 | 10 | 10 | 10 | 10 | 10 | 10 | 10 |
| Physical properties | | Viscosity [Pa · s] | 30 | 30 | 30 | 30 | 30 | 30 | 30 |
| of conductive paste | | Viscosity ratio | 2.3 | 3.0 | 2.0 | 2.4 | 2.7 | 3.3 | 3.6 |
| | | Phase difference[°] | 74 | 67 | 75 | 72 | 68 | 65 | 63 |
| Process of manufacturing | | Firing peak | 700 | 700 | 700 | 700 | 700 | 700 | 700 |
| electronic component | | temperature[°C] | | | | | | | |
| Evaluation results | | Density | 1 | 2 | 1 | 2 | 3 | 3 | 2 |
| | | Fired film thickness | 1 | 2 | 1 | 2 | 3 | 3 | 2 |
| | | | Exper- | Exper- | Exper- | Exper- | Exper- | Exper- | Exper- |
| | | | iment | iment | iment | iment | iment | iment | iment |
| | | | Exam- | Exam- | Exam- | Exam- | Exam- | Exam- | Exam- |
| | | | ple | ple | ple | ple | ple | ple | ple |
| | | | 8 * | 9 * | 10 | 11 | 12 | 13 | 14 * |
| Paste | Conductive | Copper powder 1 | — | — | — | — | — | — | — |
| composition | powder | Copper powder 2 | — | — | — | — | — | — | — |
| [parts | | Copper powder 3 | — | — | — | — | — | — | — |
| by mass] | | Copper powder 4 | — | — | — | — | — | — | — |
| | | Copper powder 5 | — | — | — | — | — | — | — |
| | | Copper powder 6 | — | — | — | — | — | — | — |
| | | Copper powder 7 | — | — | — | — | — | — | — |
| | | Copper powder 8 | 100 | — | — | — | — | — | — |
| | | Copper powder 9 | — | 100 | — | — | — | — | — |
| | | Copper powder 10 | — | — | 100 | — | — | — | — |
| | | Copper powder 11 | — | — | — | 100 | — | — | — |
| | | Copper powder 12 | — | — | — | — | 100 | — | — |
| | | Copper powder 13 | — | — | — | — | — | 100 | — |
| | | Copper powder 14 | — | — | — | — | — | — | 100 |
| | Surface | Dimethyl stearylamine | 0.2 | 0.2 | 0.2 | 0.2 | 0.2 | 0.2 | 0.2 |
| | treatment agent | | | | | | | | |
| | Binder resin | Acrylic resin 1 | 7 | 7 | 7 | 7 | 7 | 7 | 7 |
| | Glass frit | Glass frit 4 | 10 | 10 | 10 | 10 | 10 | 10 | 10 |

| Physical properties | Viscosity [Pa · s] | 30 | 30 | 30 | 30 | 30 | 30 | 30 |
|---|---|---|---|---|---|---|---|---|
| of conductive paste | Viscosity ratio | 4.0 | 4.5 | 3.5 | 3.1 | 2.4 | 2.5 | 2.2 |
| | Phase difference[°] | 60 | 54 | 63 | 66 | 71 | 73 | 76 |
| Process of manufacturing | Firing peak | 700 | 700 | 700 | 700 | 700 | 700 | 700 |
| electronic component | temperature[°C] | | | | | | | |
| Evaluation results | Density | 1 | 2 | 3 | 3 | 3 | 2 | 1 |
| | Fired film thickness | 1 | 1 | 2 | 3 | 3 | 3 | 2 |

TABLE 4

| | | | Exper- | Exper- | Exper- | Exper- | Exper- | Exper- | Exper- | Exper- |
|---|---|---|---|---|---|---|---|---|---|---|
| | | | iment | iment | iment | iment | iment | iment | iment | iment |
| | | | Exam- | Exam- | Exam- | Exam- | Exam- | Exam- | Exam- | Exam- |
| | | | ple | ple | ple | ple | ple | ple | ple | ple |
| | | | 15 | 16 | 5 | 17 | 18 | 19 | 3 | 20 |
| Paste | Conductive | Copper powder 2 | — | — | — | — | — | — | — | — |
| composition | powder | Copper powder 3 | — | — | — | — | 20 | 45 | 100 | — |
| [parts by | | Copper powder 5 | — | — | 100 | 90 | 80 | 55 | — | — |
| mass] | | Copper powder 15 | 100 | — | — | — | — | — | — | — |
| | | Copper powder 16 | — | 100 | — | — | — | — | — | — |
| | | Copper powder 17 | — | — | — | — | — | — | — | 100 |
| | | Copper powder 18 | — | — | — | — | — | — | — | — |
| | | Copper powder 19 | — | — | — | — | — | — | — | — |
| | | Copper powder 20 | — | — | — | — | — | — | — | — |
| | | Copper powder 21 | — | — | — | — | — | — | — | — |
| | | Copper powder 22 | — | — | — | — | — | — | — | — |
| | | Silver powder 1 | — | — | — | 10 | — | — | — | — |
| | Surface | Dimethyl | 0.2 | 0.2 | 0.2 | 0.2 | 0.2 | 0.2 | 0.2 | — |
| | treatment | stearylamine | | | | | | | | |
| | agent | Stearylamine | — | — | — | — | — | — | — | 0.2 |
| | | Laurylamine | — | — | — | — | — | — | — | — |
| | Binder resin | Acrylic resin 1 | 7 | 7 | 7 | 7 | 7 | 7 | 7 | 7 |
| | Glass frit | Glass frit 4 | 10 | 10 | 10 | 10 | 10 | 10 | 10 | 10 |

| Physical properties | Viscosity [Pa · s] | 30 | 30 | 30 | 30 | 30 | 30 | 30 | 30 |
|---|---|---|---|---|---|---|---|---|---|
| of conductive paste | Viscosity ratio | 3.1 | 3.5 | 2.7 | 3.3 | 2.5 | 2.3 | 2.0 | 2.5 |
| | Phase difference[°] | 65 | 61 | 68 | 64 | 70 | 72 | 75 | 70 |
| Process of manufacturing | Firing peak | 700 | 700 | 700 | 700 | 700 | 700 | 700 | 700 |
| electronic component | temperature[°C] | | | | | | | | |
| Evaluation results | Density | 3 | 2 | 3 | 3 | 3 | 2 | 1 | 3 |
| | Fired film thickness | 2 | 2 | 3 | 3 | 3 | 2 | 1 | 3 |

| | | | Exper- | Exper- | Exper- | Exper- | Exper- | Exper- | Exper- |
|---|---|---|---|---|---|---|---|---|---|
| | | | iment | iment | iment | iment | iment | iment | iment |
| | | | Exam- | Exam- | Exam- | Exam- | Exam- | Exam- | Exam- |
| | | | ple | ple | ple | ple | ple | ple | ple |
| | | | 21 | 2 | 22 | 23 | 5 | 24 | 25 |
| Paste | Conductive | Copper powder 2 | — | 100 | — | — | — | — | — |
| composition | powder | Copper powder 3 | — | — | — | — | — | — | — |
| [parts by | | Copper powder 5 | — | — | — | — | 100 | — | — |
| mass] | | Copper powder 15 | — | — | — | — | — | — | — |
| | | Copper powder 16 | — | — | — | — | — | — | — |
| | | Copper powder 17 | — | — | — | — | — | — | — |
| | | Copper powder 18 | 100 | — | — | — | — | — | — |
| | | Copper powder 19 | — | — | 100 | — | — | — | — |
| | | Copper powder 20 | — | — | — | 100 | — | — | — |
| | | Copper powder 21 | — | — | — | — | — | 100 | — |
| | | Copper powder 22 | — | — | — | — | — | — | 100 |
| | | Silver powder 1 | — | — | — | — | — | — | — |
| | Surface | Dimethyl | — | — | 0.01 | 0.05 | 0.2 | 1 | 2 |
| | treatment | stearylamine | | | | | | | |
| | agent | Stearylamine | — | — | — | — | — | — | — |
| | | Laurylamine | 0.2 | — | — | — | — | — | — |
| | Binder resin | Acrylic resin 1 | 7 | 7 | 7 | 7 | 7 | 7 | 7 |
| | Glass frit | Glass frit 4 | 10 | 10 | 10 | 10 | 10 | 10 | 10 |

| Physical properties | Viscosity [Pa · s] | 30 | 30 | 30 | 30 | 30 | 30 | 30 |
|---|---|---|---|---|---|---|---|---|
| of conductive paste | Viscosity ratio | 3.3 | 3.0 | 3.0 | 2.9 | 2.7 | 2.5 | 2.3 |
| | Phase difference[°] | 65 | 67 | 68 | 67 | 68 | 70 | 73 |
| Process of manufacturing | Firing peak | 700 | 700 | 700 | 700 | 700 | 700 | 700 |
| electronic component | temperature[°C] | | | | | | | |
| Evaluation results | Density | 3 | 2 | 3 | 3 | 3 | 2 | 2 |

| | | | | | | | |
|---|---|---|---|---|---|---|---|
| Fired film thickness | 3 | 2 | 2 | 3 | 3 | 3 | 2 |

TABLE 5

| | | | Exper- | Exper- | Exper- | Exper- | Exper- | Exper- | Exper- | Exper- |
|---|---|---|---|---|---|---|---|---|---|---|
| | | | iment | iment | iment | iment | iment | iment | iment | iment |
| | | | Exam- | Exam- | Exam- | Exam- | Exam- | Exam- | Exam- | Exam- |
| | | | ple | ple | ple | ple | ple | ple | ple | ple |
| | | | 26 * | 27 | 28 | 5 | 29 | 30 * | 31 | 32 |
| Paste | Conductive | Copper powder 5 | 100 | 100 | 100 | 100 | 100 | 100 | 100 | 100 |
| composition | powder | | | | | | | | | |
| [parts by | Surface treatment | Dimethyl | 0.2 | 0.2 | 0.2 | 0.2 | 0.2 | 0.2 | 0.2 | 0.2 |
| mass] | agent | stearylamine | | | | | | | | |
| | Binder resin | Acrylic resin 1 | 7 | 7 | 7 | 7 | 7 | 7 | 7 | 7 |
| | Glass frit | Glass frit 1 | 10 | — | — | — | — | — | — | — |
| | | Glass frit 2 | — | 10 | — | — | — | — | — | — |
| | | Glass frit 3 | — | — | 10 | — | — | — | — | — |
| | | Glass frit 4 | — | — | — | 10 | — | — | — | — |
| | | Glass frit 5 | — | — | — | — | 10 | — | — | — |
| | | Glass frit 6 | — | — | — | — | — | 10 | — | — |
| | | Glass frit 7 | — | — | — | — | — | — | 10 | — |
| | | Glass frit 8 | — | — | — | — | — | — | — | 10 |

| Physical properties | Viscosity [Pa · s] | 30 | 30 | 30 | 30 | 30 | 30 | 30 | 30 |
|---|---|---|---|---|---|---|---|---|---|
| of conductive paste | Viscosity ratio | 4.0 | 3.8 | 3.3 | 2.7 | 2.4 | 2.1 | 2.9 | 3.1 |
| | Phase difference[°] | 59 | 63 | 66 | 68 | 73 | 76 | 66 | 64 |
| Process of manufacturing | Firing peak | 700 | 700 | 700 | 700 | 700 | 700 | 700 | 700 |
| electronic component | temperature[°C] | | | | | | | | |
| Evaluation results | Density | 3 | 3 | 3 | 3 | 3 | 2 | 3 | 2 |
| | Fired film thickness | 1 | 2 | 3 | 3 | 3 | 1 | 3 | 2 |

TABLE 6

| | | | Exper- | Exper- | Exper- | Exper- | Exper- | Exper- | Exper- | Exper- | Exper- | Exper- | Exper- |
|---|---|---|---|---|---|---|---|---|---|---|---|---|---|
| | | | iment | iment | iment | iment | iment | iment | iment | iment | iment | iment | iment |
| | | | Exam- | Exam- | Exam- | Exam- | Exam- | Exam- | Exam- | Exam- | Exam- | Exam- | Exam- |
| | | | ple | ple | ple | ple | ple | ple | ple | ple | ple | ple | ple |
| | | | 33 | 34 | 35 | 36 | 37 | 38 | 39 | 40 | 41 | 42 | 43 |
| Paste | Conductive | Copper | 100 | 100 | 100 | 100 | 100 | 100 | 100 | 100 | 100 | 100 | 100 |
| composition | powder | powder 5 | | | | | | | | | | | |
| [parts | Surface | Dimethyl | 0.2 | 0.2 | 0.2 | 0.2 | 0.2 | 0.2 | 0.2 | 0.2 | 0.2 | 0.2 | 0.2 |
| by mass] | treatment | stearylamine | | | | | | | | | | | |
| | agent | | | | | | | | | | | | |
| | Binder | Acrylic resin 1 | 7 | 7 | 7 | 12 | 9 | 5 | — | — | 7 | 7 | 7 |
| | resin | Acrylic resin 2 | — | — | — | — | — | — | 5 | 4 | — | — | — |
| | Glass frit | Glass frit 4 | 10 | 10 | 10 | 10 | 10 | 10 | 10 | 10 | 10 | 10 | 10 |

| Physical properties | Viscosity | 15 | 45 | 80 | 30 | 30 | 30 | 30 | 30 | 30 | 30 | 30 |
|---|---|---|---|---|---|---|---|---|---|---|---|---|
| of conductive paste | [Pa · s] | | | | | | | | | | | |
| | Viscosity | 2.5 | 2.8 | 3.3 | 1.5 | 2.0 | 10.3 | 20.0 | 30.4 | 2.7 | 2.7 | 2.7 |
| | ratio | | | | | | | | | | | |
| | Phase | 70 | 66 | 64 | 85 | 80 | 59 | 45 | 39 | 68 | 68 | 68 |
| | difference[°] | | | | | | | | | | | |
| Process of manufacturing | Firing peak | 700 | 700 | 700 | 700 | 700 | 700 | 700 | 700 | 720 | 680 | 700 |
| electronic component | temper- | | | | | | | | | | | |
| | ature[°C] | | | | | | | | | | | |
| Evaluation results | Density | 3 | 3 | 3 | 3 | 3 | 3 | 3 | 3 | 3 | 3 | 3 |
| | Fired film | 2 | 3 | 2 | 2 | 3 | 3 | 3 | 2 | 3 | 3 | 3 |
| | thickness | | | | | | | | | | | |

### <Evaluation of Physical Properties of Conductive Paste>

### (Viscosity)

The viscosity of the conductive paste was measured under conditions of 25 °C and a shear rate of 4 s⁻¹ using a rotational viscometer (model number: HADV-II+Pro, commercially available from Brookfield).

### (Viscosity Ratio)

The viscosity of the conductive paste was measured under conditions of 25 °C, a shear rate of 0.4 s⁻¹ and a shear rate of 40 s⁻¹ using a rotational viscometer (model number: HADV-II+Pro, commercially available from Brookfield). The ratio of the viscosity at a shear rate of 0.4 s⁻¹ to the viscosity at a shear rate of 40 s⁻¹ was calculated as the viscosity ratio.

### (Phase Difference)

Using a rheometer (model number: AR2000, commercially available from TA Instrument), under conditions of 25 °C, an angular frequency of 1 Hz, and a strain of 1%, measurement was performed using a parallel plate with a diameter of 40 mm, and the value of the phase difference of the conductive paste was obtained.

### <Evaluation Test of Terminal Electrode>

### (Preparation of Electronic Component Including Terminal Electrode)

A laminated body having a substantially rectangular parallelepiped shape with a length of 0.6 mm, a width of 0.3 mm, and a height of 0.3 mm in which a plurality of dielectric layers containing barium titanate and internal electrode layers containing nickel were laminated was prepared. The conductive paste was applied to an end of the laminated body where an internal electrode was exposed by a dip printing method with the laminated body lowered at a rate of 300 μm/s and lifted at a rate of 100 μm/s, and the sample was then left in an air atmosphere and 150 °C for 10 minutes. Then, in a nitrogen atmosphere, the temperature was raised at a temperature increase rate of 50 °C/min and reached the temperature shown in Tables 3 to 6, and the sample was then left for 15 minutes to form a terminal electrode, and thereby an electronic component including the terminal electrode was prepared.

### (Preparation of Evaluation Test Sample)

In each experiment example, the above 20 electronic components were prepared. Each electronic component was embedded in a resin, and in the electronic components, each electronic component was cut through the central area of both end-face parts of each electronic component in a lamination direction (direction perpendicular to the dielectric layers and the internal electrode layers) to expose a cross section of each electronic component, and evaluation test samples were prepared, and evaluated as follows.

### (Terminal Electrode Density (Electrode Area Proportion))

The above evaluation test samples were observed under a scanning electron microscope, and in 10 fields of view for each sample with a total of 200 fields of view, and the proportion of the electrode area in the field of view was calculated as an electrode area proportion. The value of the electrode area proportion was evaluated based on the following evaluation criteria, and a score of 1 to 3 was applied. A score of 2 or more was evaluated to be satisfactory.

### <Evaluation Criteria>

3: the electrode area proportion was 99% or more
2: the electrode area proportion was 90% or more and less than 99%
1: the electrode area proportion was less than 90%

### (Fired Film Thickness of Terminal Electrode)

The above evaluation test samples were observed under a scanning electron microscope, the thickness (maximum thickness) of the thickest part and the thickness (minimum thickness) of the thinnest part of the terminal electrode (fired film) were measured, and the average value of the maximum thicknesses and the average value of the minimum thicknesses were calculated for each experiment example. The average value of the maximum thicknesses and the average value of the minimum thicknesses were evaluated based on the following evaluation criteria, and a score of 1 to 3 was applied. A score of 2 or more was evaluated to be satisfactory.

### <Evaluation Criteria>

3: average value of maximum thicknesses ≤20 μm, and average value of minimum thicknesses ≥2.5 μm
2: average value of maximum thicknesses ≤40 μm, and average value of minimum thicknesses ≥1.0 μm (provided that a case corresponding to a score of 3 was excluded)
1: average value of maximum thicknesses >40 μm, or average value of minimum thicknesses <1.0 μm

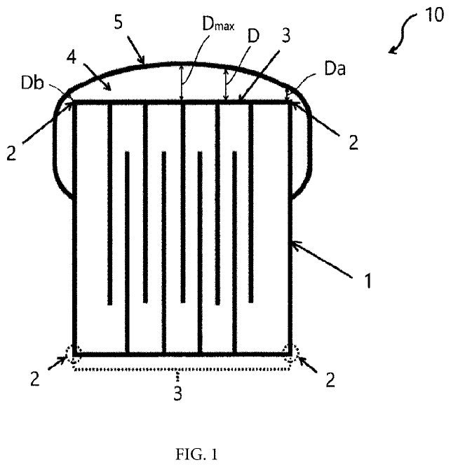

A method for measuring a fired film thickness will be described with reference to FIG. 1.

FIG. 1 is a schematic view showing an evaluation test sample 10 obtained by forming a terminal electrode 4 on a laminated body 1 using a conductive paste.

In the cross section of the evaluation test sample 10 observed under the scanning electron microscope, when a perpendicular line was drawn from the outer periphery 5 of the terminal electrode 4 to an end-face part 3 of the laminated body 1, the length of the perpendicular line was defined as D. The thickness at the point where the D was the largest was measured, and the value of the thickness was defined as the maximum thickness Dₘₐₓ. In addition, the thickness Da at the point where the D value was smallest, and the thickness Db at the point where the distance between a corner part 2 of the laminated body 1 and the outer periphery 5 of the terminal electrode 4 was shortest were measured, and the smaller value between Da and Db was defined as the minimum thickness Dₘᵢₙ. Here, in the cross section of the evaluation test sample 10 observed under the scanning electron microscope, when there was a point where the laminated body 1 was exposed due to a hole in the terminal electrode 4, the minimum thickness was set to “0 μm.”

As can be clearly understood from the above experiment examples, when the conductive paste of the present invention is used, a thin, dense and highly continuous terminal electrode can be formed while maintaining high productivity even when firing is performed at a low temperature of 720 °C or lower.

### REFERENCE CHARACTER LIST

1 Laminated body
2 Corner part
3 End-face part
4 Terminal electrode
5 Outer periphery
10 Evaluation test sample
D Length of perpendicular line when perpendicular line is drawn from outer periphery to end-face part
Da Thickness at point where value of D is smallest
Db Thickness at point where distance between corner part and the outer periphery is shortest
Dₘₐₓ Thickness at point where D is largest
Dₘᵢₙ Smaller value between Da and Db

1. A conductive paste comprising: a conductive powder mainly composed of copper; a glass frit; a binder resin; and an organic solvent, wherein
in the conductive powder mainly composed of copper, a volume-based cumulative 50% particle size D50_{C} in laser diffraction particle size distribution measurement is 0.3 μm or more and 4.5 μm or less, a ratio of an average major axis X to an average minor axis Y is 1.0 or more and 3.0 or less, and a ratio of the average major axis X to an average thickness Z defined below is 1.1 or more and 9.0 or less, and
the glass frit has a volume-based cumulative 50% particle size D50_{G} of 0.3 μm or more and 2.0 μm or less in laser diffraction particle size distribution measurement,
(Average Thickness)
The conductive paste containing the conductive powder mainly composed of copper is cast onto a PET film using an applicator to form a coating film with a film thickness of 250 μm, the coating film is dried in an air atmosphere, 150 °C, and 10 minutes to form a dry film, a cross section of the dry film is exposed by ion milling, the cross section of the dry film is observed under a scanning electron microscope, 500 conductive particles are randomly selected, the minor axis is measured as thickness, an average value of the thicknesses is determined, and this average value is defined as an “average thickness.”

2. The conductive paste according to claim 1, wherein the conductive powder mainly composed of copper contains an aliphatic amine on at least a part of the surface.

3. The conductive paste according to claim 2, wherein an amount of the aliphatic amine is 0.01 parts by mass or more and 1.0 part by mass or less with respect to 100 parts by mass of the conductive powder mainly composed of copper.

4. The conductive paste according to claim 1, wherein, when a volume-based cumulative 10% particle size of the glass frit is defined as D10_{G}, and a volume-based cumulative 90% particle size thereof is defined as D90_{G} in laser diffraction particle size distribution measurement, (D90_{G}−D10_{G})/D50_{G} is 7.5 or less.

5. The conductive paste according to claim 1, wherein, when a volume-based cumulative 10% particle size of the conductive powder mainly composed of copper is defined as D10_{C}, and a volume-based cumulative 90% particle size thereof is defined as D90_{C} in laser diffraction particle size distribution measurement, (D90_{C}−D10_{C})/D50c is 7.5 or less.

6. The conductive paste according to claim 1, which satisfies at least any of a condition in which ratio of viscosity at a shear rate of 0.4 s⁻¹ to viscosity at a shear rate of 40 s⁻¹ when measured at 25 °C is 2.0 or more and 20.0 or less and a condition in which, when a strain of 1% is applied to the conductive paste at an angular frequency of 1 Hz, a phase difference 6 between the strain and stress generated by the strain has a value of 450 or more and 80° or less.

7. The conductive paste according to claim 1, which satisfies all of a condition in which an electrode area proportion of a terminal electrode is 90% or more, a condition in which an average value of the maximum thicknesses of the terminal electrodes is 40 μm or less, and a condition in which an average value of the minimum thicknesses of the terminal electrodes is 1.0 μm or more, which are calculated by evaluation tests below:
<Electrode Area Proportion Evaluation Test of Terminal Electrode>
An evaluation test sample prepared by a method below for preparing an evaluation test sample is observed under a scanning electron microscope in 10 fields of view for each sample, and a proportion of the electrode area in the observation field of view is calculated as an electrode area proportion of the terminal electrode;
<Maximum Thickness Evaluation Test of Terminal Electrode>
An evaluation test sample prepared by a method below for preparing an evaluation test sample is observed under a scanning electron microscope, and in the evaluation test sample, when a perpendicular line is drawn from an outer periphery of the terminal electrode to an end-face part of the laminated body, a point where the length of the perpendicular line is the largest is measured as the maximum thickness, the maximum thicknesses of the 20 electronic components, for which the maximum thickness thereof is measured, are averaged to calculate an average value of the maximum thicknesses of the terminal electrodes;
<Minimum Thickness Evaluation Test of Terminal Electrode>
An evaluation test sample prepared by a method below for preparing an evaluation test sample is observed under a scanning electron microscope, and in the evaluation test sample, when a perpendicular line is drawn from an outer periphery of the terminal electrode to an end-face part of the laminated body, the thickness at a point where the length of the perpendicular line is the smallest, and the thickness at the point where a distance between the corner part of the laminated body and the outer periphery of the terminal electrode is shortest are measured, the thickness of the thinnest part among these is measured as the minimum thickness, and the minimum thicknesses of the 20 electronic components, for which the minimum thickness thereof is measured, are averaged to calculate an average value of the minimum thicknesses of the terminal electrodes; and
<Method for Preparing Evaluation Test Sample>
A laminated body having a rectangular parallelepiped shape with a length of 0.6 mm, a width of 0.3 mm, and a height of 0.3 mm and in which a plurality of dielectric layers containing barium titanate and internal electrode layers containing nickel are laminated is prepared, the conductive paste is applied to an end of the laminated body where an internal electrode is exposed by a dip printing method, with the laminated body being lowered at a rate of 300 μm/s and being lifted at a rate of 100 μm/s, the sample is then left in an air atmosphere and 150 °C for 10 minutes, then heated at a temperature increase rate of 50 °C/min in a nitrogen atmosphere, and left for 15 minutes after the temperature reaches 720 °C to form a terminal electrode, 20 electronic components including the terminal electrode are prepared, the 20 electronic components are each embedded in a resin, and in the electronic components, each of the electronic components is cut through the central area of both end-face parts of each electronic component in a lamination direction (direction perpendicular to the dielectric layers and the internal electrode layers) to expose a cross section of each of the electronic components, and thereby an evaluation test sample is prepared.

8. A method for manufacturing an electronic component, the method comprising:
a laminated body preparing step of preparing a laminated body for a multilayer electronic component including a plurality of ceramic layers and a plurality of internal electrode layers; and
a terminal electrode forming step of applying a conductive paste to an exposed end of an internal electrode of the laminated body, and then firing the applied conductive paste, thereby forming a terminal electrode,
wherein the conductive paste is the conductive paste according to claim 1.

9. The method for manufacturing an electronic component according to claim 8, wherein a peak temperature during firing is 720 °C or lower.
